(19) United States
(12) Patent Application Publication
(10) Pub. No.: US 2011/0308410 A1
(43) Pub. Date: Dec. 22, 2011

(54) Cylinders With Bearing Rings For Offset Print Machines

(75) Inventor: Jose Betes Peruga, Sant Cugat Del Valles (ES)

(73) Assignee: ROTATEK, S.A., Sant Gugat Del Valles (ES)

(21) Appl. No.: 12/375,399

(22) PCT Filed: Jul. 25, 2007
(86) PCT No.: PCT/IB07/52959

§ 371 Date: Aug. 26, 2009

(30) Foreign Application Priority Data
Jul. 27, 2006 (ES) U 200601782

(51) Int. Cl. B41F 13/10

(52) U.S. Cl. 101/378

(57) ABSTRACT

Said machines comprise at least a first cylinder (1) for a printing plate, a second transfer cylinder (2) and a third cylinder, printing or counter-cylinder, with both first (1) and second (2) cylinders being hollow, through the interior of which a shaft (5, 6) is inserted belonging to the machine and in that said hollow cylinders (1, 2) of lightweight material, comprise rigid bearing rings (7, 8) located at the ends of the referred cylinders, with the same diameter or somewhat greater than the blanket or printing plate (4, 14), taking said diameter from the cylinder shaft (5, 6).

Cylinder with bearing rings for offset print machines of the type in which said machines comprise at least a first cylinder for a printing plate, a second transfer cylinder and a third cylinder, printing or counter-cylinder, with both first and second cylinders hollow, through the interior of which a shaft is inserted belonging to the machine that is characterised in that said hollow cylinders of lightweight material, comprise rigid bearing rings located at the ends of the referred cylinders, with the same diameter or somewhat greater than the blanket or printing plate, taking said diameter from the cylinder shaft.

### BRIEF DISCLOSURE OF THE INVENTION

The present invention is intended to be an improvement and modernisation of offset-type printing machines, lightening the weight of their cylinders, allowing their simple replacement, together with eliminating possible problems with the rubber blanket.

For this reason, thought has been given to the use of a hollow cylinder as a sleeve in order to reduce weight.

Thus, rigid rings are employed, located at the ends of the referred cylinder, with the same diameter or significantly larger (taken from the cylinder axis) than the printing plate or rubber blanket. This is so, because a pressure is required between the cylinders that support these rings so that the blanket only prints, but is not under pressure from the counter-cylinder or the printing plate.

In order to assist sleeve securing to the machine shaft so that when the shaft rotates, the sleeve of blanket also rotates, internal beatings have been designed to secure it to the shaft inside the referred rings.

One objective of the present machine is a cylinder with bearing rings for offset print machines of the type in which said machines comprise at least a first cylinder for a printing plate, a second transfer cylinder and a third cylinder, printing or counter-cylinder, with both first and second cylinders hollow, through the interior of which a shaft is inserted belonging to the machine that is characterised in that said hollow cylinders of lightweight material, comprise rigid bearing rings located at the ends of the referred cylinders, with the same diameter or somewhat greater than the blanket or printing plate, taking said diameter from the cylinder shaft.

### BRIEF DESCRIPTION OF THE DRAWINGS

In order to facilitate the description, the present report is accompanied by one sheet of drawings that show a practical exemplary embodiment case, which is cited as a non-limiting example of the scope of the present invention:

FIG. 1 is a lateral section view of the first and second cylinders in their operating positions.

### A SPECIFIC EMBODIMENT EXAMPLE OF THE INVENTION

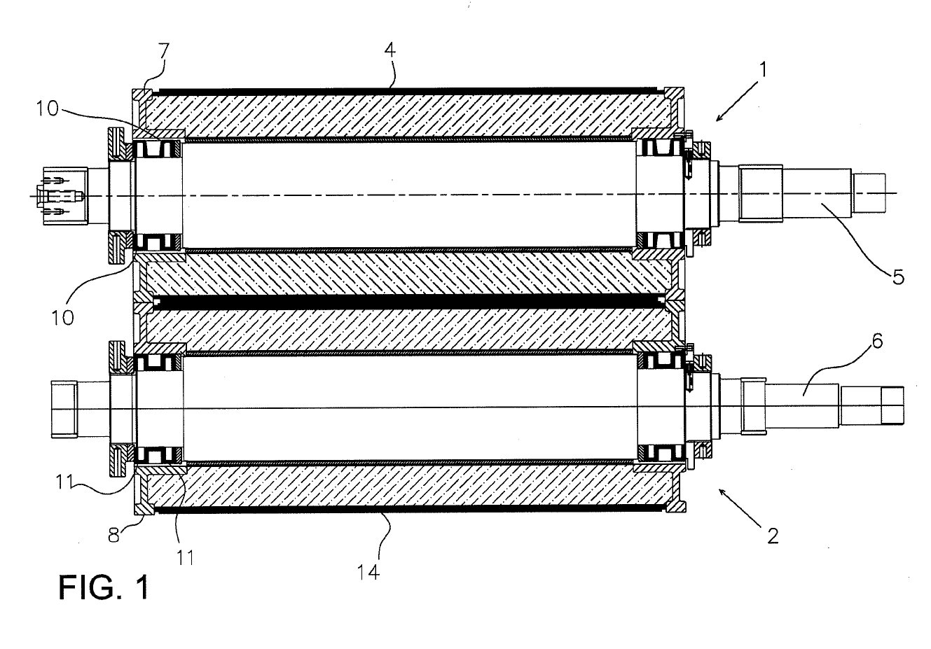

FIG. 1 illustrates a first cylinder 1, with its blanket or printing plate 4, its bearing rings 7, its internal bearings 10 and its shaft 5, together with a second cylinder 2, with its blanket or printing plate 14, its bearing rings 8, its internal bearings 11 and its shaft 6.

Thus, in a specific embodiment example, the first cylinder 1 is installed, with an identical procedure for the second cylinder 2.

In this way, shaft 5 is introduced inside the first hollow lightweight cylinder 1 in such a way that the shaft ends fit into the internal bearings 10 of the first cylinder 1.

In this embodiment example, the first cylinder 1 is located above the second 2, just as shown in FIG. 1.

As can be seen, the bearing rings 7, 8 of both cylinders are in contact, together with the blankets of printing plates 4, 14, although the latter can be separated by a certain distance if desired, for printing reasons.

When both cylinders 1,2 rotate due to shaft 5, 6 operation and assisted by the internal bearings 10, 11, the bearing rings 7, 8 have to withstand the pressure and prevent the blankets 4, 14 from having to support any pressure, in this way the blankets only print, but do not come under any pressure.

The present invention describes a new cylinder with bearing rings for offset print machines. The examples described here do not limit the present invention and it may have various applications and/or adaptations, all of which are within the scope of the following claims.

1. Cylinder with bearing rings for offset print machines of the type in which said machines comprise at least a first cylinder (1) for a printing plate, a second transfer cylinder (2) and a third cylinder, printing or counter-cylinder, with both first (1) and second (2) cylinders hollow, through the interior of which a shaft (5, 6) is inserted belonging to the machine that is characterised in that said hollow cylinders (1, 2) of lightweight material, comprise rigid bearing rings (7, 8) located at the ends of the referred cylinders, with the same diameter or somewhat greater than the blanket or printing plate (4, 14), taking said diameter from the cylinder shaft (5,6).

2. A sleeve according to claim 1 characterised in that there are internal bearings (10, 11) inside the rigid rings (7, 8) for securing to the shaft (5, 6).
